(19) United States
(12) Patent Application Publication
(10) Pub. No.: US 2009/0046037 A1
(43) Pub. Date: Feb. 19, 2009

(54) HIGH RESOLUTION DISPLAY OF 3D IMAGES

(75) Inventors: Lorne A. Whitehead, Vancouver (CA); Michele Ann Mossman, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: THE UNIVERSITY OF BRITISH COLUMBIA, Vancouver (CA)

(21) Appl. No.: 11/840,474

(22) Filed: Aug. 17, 2007

(51) Int. Cl. G09G 3/00

(52) U.S. Cl. 345/32

(57) ABSTRACT

A 3D display has a backlight, image panel, lens array, and aperture mask. The lens array has a plurality of converging lenses having optical axes perpendicular to the image panel. The aperture mask has a plurality of electro-optic elements. Each element is aligned closely proximate to a corresponding one of the lenses and is selectably switchable between “on” to permit passage of light rays through the element, or “off” to prevent passage of light rays through the element. The elements are arranged in subsets of adjacent elements. A controller electronically coupled to the image panel and to the aperture mask repetitively selects an electro-optic element in each subset, switches the selected elements “on”, switches all other elements in each subset “off”, and applies to the image panel a selected plurality of representations of an image, each representation corresponding to a plurality of different viewing directions of the image.

### TECHNICAL FIELD

This disclosure pertains to the display of images in a two-dimensional (2D) plane such that a viewer perceives the displayed image as a high resolution, three-dimensional (3D) image.

### BACKGROUND

3D images can be produced by providing the viewer with special eyeglasses or headgear. The viewer looks at a pair of stereoscopic images while wearing the eyeglasses or headgear. The eyeglasses or headgear enables only one of the viewer's eyes to see only one of the images at one time. The positions of objects within each image are adjusted slightly, when the stereoscopic images are produced, to account for the parallax caused by the positional difference between a viewer's left and right eyes. The eyeglasses or headgear rapidly and sequentially present the left image of a stereoscopic image pair to the viewer's left eye, then present the right image of the stereoscopic image pair to the viewer's right eye, then again present the left image of the stereoscopic image pair to the viewer's left eye, and so on. The left and right images are alternately presented sufficiently rapidly that the alternation is imperceptible to the viewer, such that the viewer perceives depth within the displayed image. However, it can be undesirable for the viewer to wear special eyeglasses or headgear, thus restricting use of the foregoing 3D image display technique.

Some alternative 3D image display techniques do not require the viewer to wear special eyeglasses or headgear. Integral imaging employing optical structures to produce images which differ when viewed from different viewing angles is one such alternative. For example, an optical structure such as a lens sheet or an aperture mask can be positioned over a composite image made up of a number of small, juxtaposed images. Each one of the juxtaposed images corresponds to a separate view of the desired image as seen from a slightly different perspective. When a viewer looks through the optical structure at the composite image, natural movement of the viewer's head or eyes causes the viewer to see the composite image at different viewing angles. As the viewing angle changes, the viewer sees different regions of the composite image. If each region corresponds to a different one of the small, juxtaposed images the viewer perceives the composite image as having depth, within a limited range of viewing angles.

It is desirable to achieve the appearance of depth over a wide range of image viewing angles, while also maintaining high image resolution. The aforementioned stereoscopic image pair technique produces a relatively realistic 3D image without substantially degrading image resolution. However, the 3D effect is perceptible from only one viewing position, and no natural parallax is observed as the viewer's head or eyes move. More sophisticated systems utilize more images, enabling the viewer to perceive the 3D effect from different viewing positions through a range of viewing angles, and providing a somewhat natural sense of parallax shift as the viewer's head or eyes move horizontally relative to the image. However, the 3D image's resolution decreases as the depth of depicted image objects increases relative to the 2D plane in which the 3D image is displayed. These shortcomings are addressed below.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIGS. 1A and 1B are respectively not to scale, cross-sectional side elevation and top plan schematic illustrations of a viewer looking at a high resolution 3D image display.

FIG. 2 is a not to scale, greatly enlarged, rear elevation schematic illustration of a 10-aperture mask and 10-lens subset of the FIG. 1A and 1B display.

FIG. 3 is a not to scale, cross-sectional top view of the FIG. 2 structure, aligned with an imaging panel portion of the FIG. 1A and 1B display.

FIG. 4 is similar to FIG. 3 and depicts actuation of the FIG. 2 structure to permit light rays to pass through one of the structure's apertures.

FIGS. 5A and 5B—taken together—are similar to FIGS. 3 and 4, except that FIG. 5B is a front view of the imaging panel portion.

FIGS. 5C and 5D are similar to FIGS. 5A and 5B respectively, except that FIGS. 5C and 5D depict an embodiment utilizing conventional radially symmetric lenses, whereas FIGS. 5A and 5B depict an embodiment utilizing cylindrical lenses having symmetry in only one plane.

FIGS. 6A and 6B schematically depict M by N pixel arrays corresponding to embodiments utilizing cylindrical lenses (FIG. 6A) and conventional radially symmetric lenses (FIG. 6B).

FIGS. 7A-7J are similar to FIGS. 3 and 4 and schematically depict sequential actuation of the FIG. 2 structure to permit light rays to pass through different, sequentially selected ones of the structure's apertures.

FIG. 8 schematically depicts four linearly adjacent FIG. 2 structures aligned with four linearly adjacent imaging panel portions of the FIG. 1A and 1B display, and depicts actuation of the FIG. 2 structures to permit light rays to pass through one aperture in each of those structures.

FIG. 9A is a greatly enlarged, top plan view of a single lenslet for a lenticular meniscus lens array. FIG. 9B depicts an incidence angle θ for light rays incident on the FIG. 9A lenslet. FIGS. 9C-9E respectively depict passage of light rays through the FIG. 9A lenslet for different incidence angles.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

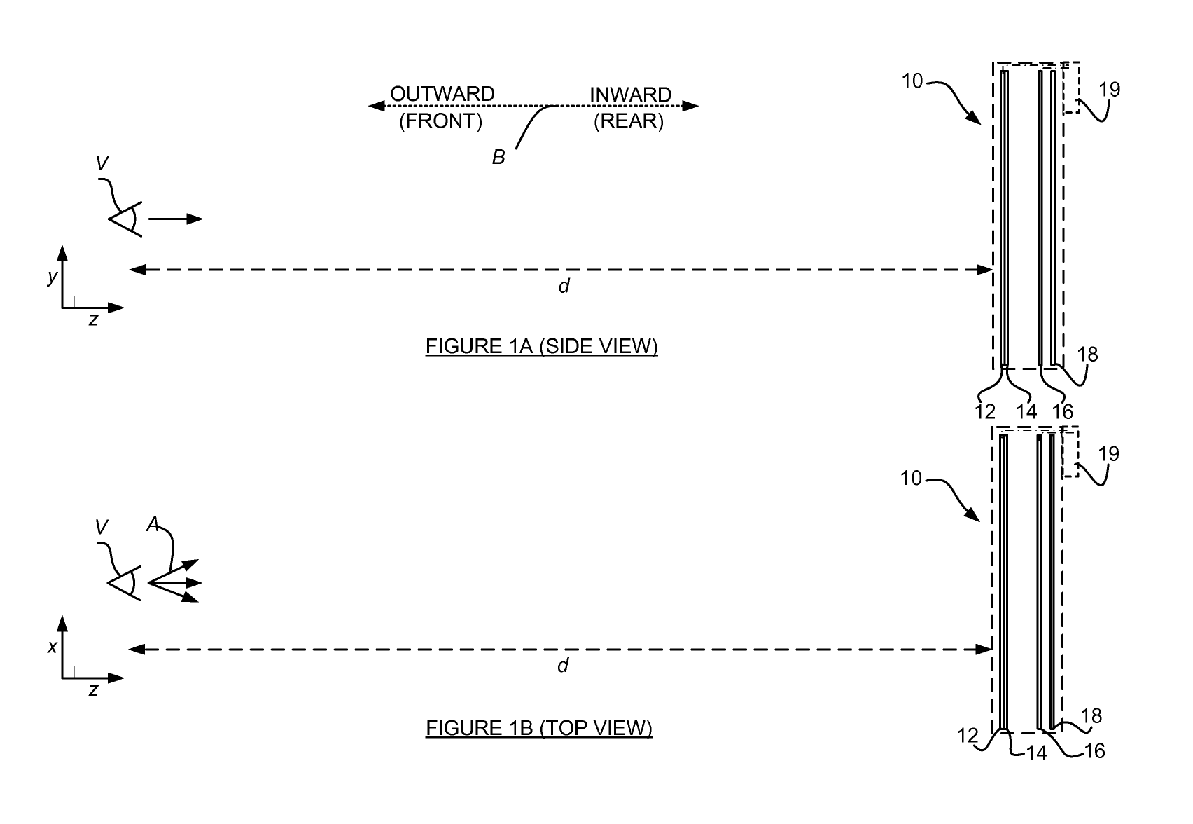

FIGS. 1A and 1B schematically depict a high resolution 3D image display 10 which viewer V observes in the z direction over an intended viewing distance d and through an angular range of horizontally distributed viewing directions A (i.e. viewing directions A are distributed in the x direction depicted in FIG. 1B). It is assumed that viewer V does not observe display 10 through a significant range of vertically distributed viewing directions (i.e. viewing directions distributed in the y direction depicted in FIG. 1A) unless radially symmetric lenses are utilized as explained below. Display 10 incorporates a substantially planar aperture mask 12 positioned on the outward side of a substantially planar lens array 14 which is in turn positioned on the outward side of a substantially planar image panel 16. Backlight 18 illuminates image panel 16. The “inward” (i.e. rearward) and “outward” (i.e. frontward) directions are indicated by double-headed arrow B in FIGS. 1A, 3, 4, 5A, 5C and 8. Controller 19 is electronically coupled to and controls the operation of aperture mask 12 and image panel 16 as explained below.

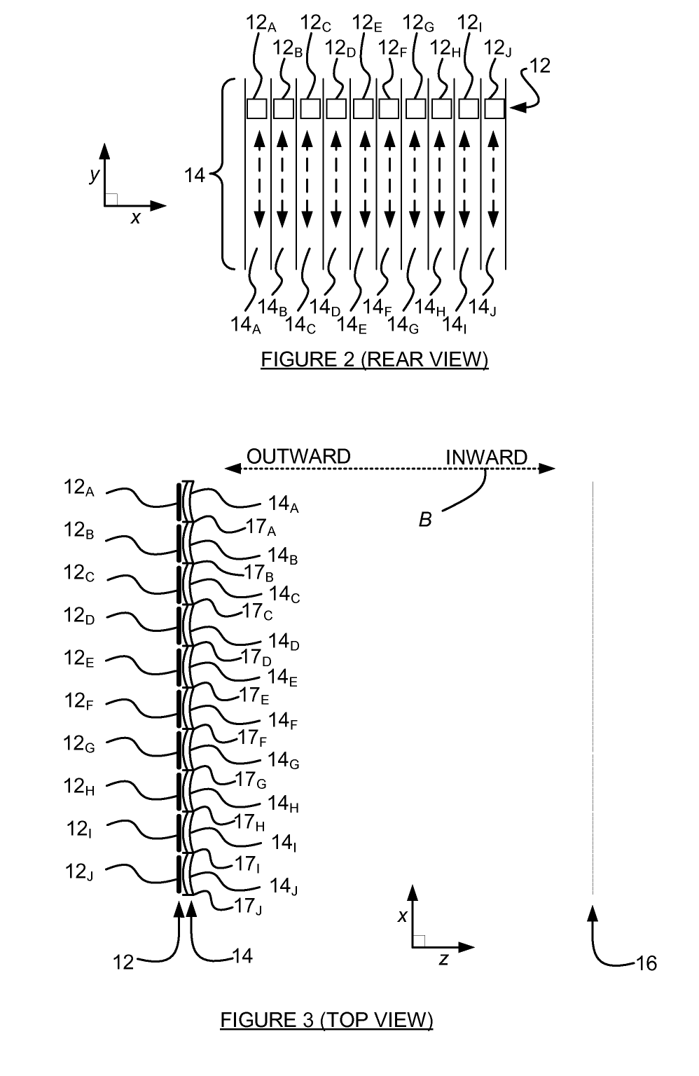

FIGS. 2, 3, 4, 5A and 5C depict a small horizontal section of display 10 consisting of a 10-aperture subset of aperture mask 12, a portion of a 10-lens subset of lens array 14 and an associated portion of image panel 16. Display 10 incorporates a large number of such sections.

Aperture mask 12 has a large plurality of selectably actuable electro-optic switches. For example, aperture mask 12 may be a liquid crystal display (LCD) panel having a large plurality of selectably actuable LCD elements arranged in regular array groups (i.e. arranged in an ordered, repeated pattern). FIGS. 2, 3 and 4 depict a group of ten selectably actuable, horizontally adjacent LCD elements 12_{A}, 12_{B}, 12_{C}, 12_{D}, 12_{E}, 12_{F}, 12_{G}, 12_{H}, 12_{I}, 12_{J}. Each LCD element is selectably actuable between an “on” state and an “off” state. When an LCD element is in the “on” state, that element is transparent—so light rays may pass through that element. When an LCD element is in the “off” state, that element is opaque—preventing passage of light rays through that element. Other selectably actuable electro-optic switches, e.g. an electrowetting display device as disclosed in international patent publication WO/2005/036517, may be used to form aperture mask 12.

Lens array 14 has a large plurality of lenses arranged in a regular array group, with one lens aligned closely proximate to each one of the LCD elements in aperture mask 12. FIGS. 2, 3 and 4 depict ten horizontally adjacent cylindrical lenses 14_{A}, 14_{B}, 14_{C}, 14_{D}, 14_{E}, 14_{F}, 14_{G}, 14_{H}, 14_{I}, 14_{J} with LCD element 12_{A} horizontally centred with respect to lens 14_{A}, LCD element 12_{B} horizontally centred with respect to lens 14_{B}, etc. The dashed double-headed arrows in FIG. 2 indicate that each one of cylindrical lenses 14_{A}, 14_{B}, 14_{C}, 14_{D}, 14_{E}, 14_{F}, 14_{G}, 14_{H}, 14_{I}, 14_{J} extends in the y direction depicted in FIG. 2. Lenses 14_{A}, 14_{B}, 14_{C}, 14_{D}, 14_{E}, 14_{F}, 14_{G}, 14_{H}, 14_{I}, 14_{J} have uniform size and shape. The lenses are aligned with their optical axes substantially parallel to one another, and substantially perpendicular to the macroscopic x-y plane of lens array 14 (i.e. the lenses' optical axes are substantially parallel to the depicted z direction—it being understood that the x, y and z directions are mutually perpendicular). The lenses are sufficiently small that they are not individually distinguishable when viewer V looks at display 10 over the intended viewing distance d. For example, each lens may be about 1 mm in diameter. Alternatively, the shortest physical extent of each lens, perpendicular to the optical axis of the lens, may be between 0.5 mm to 1.5 mm.

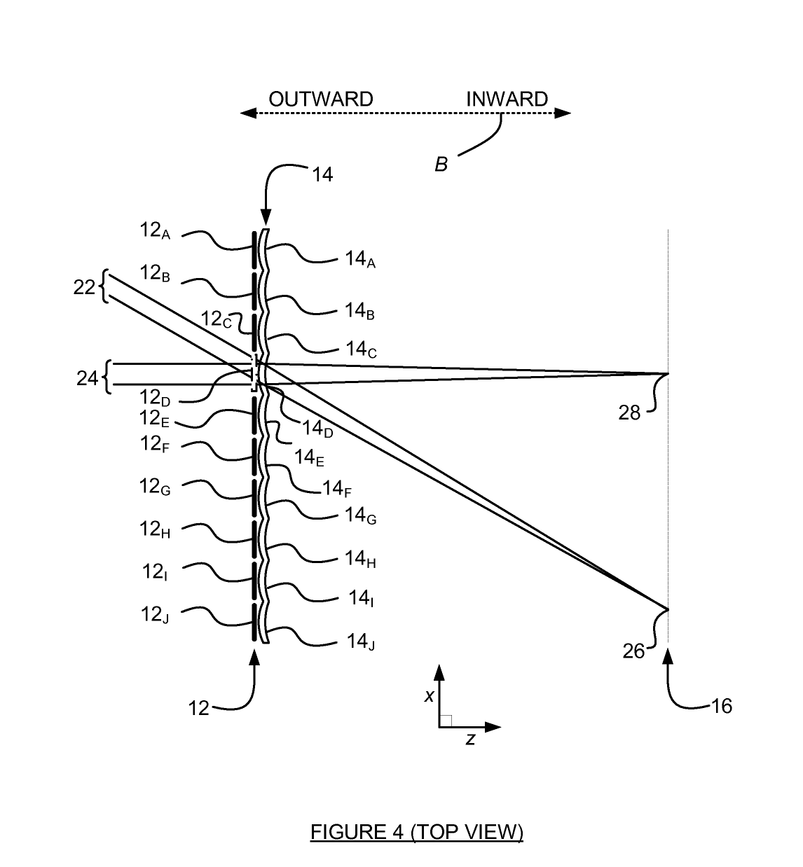

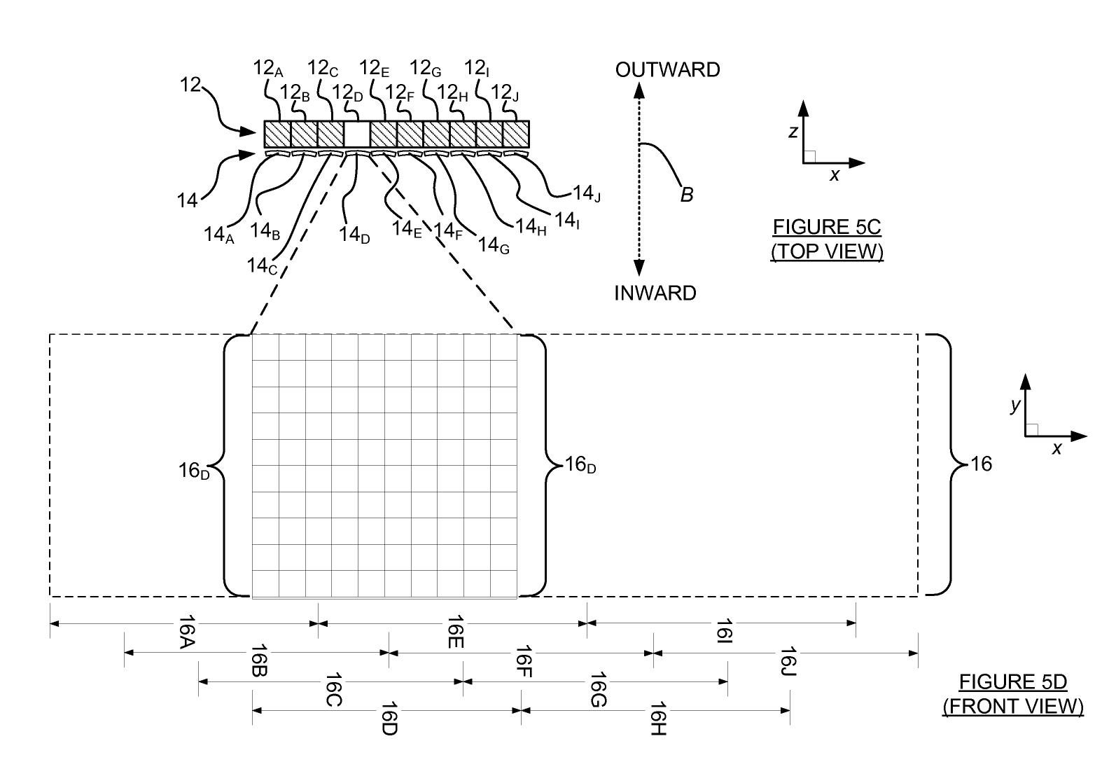

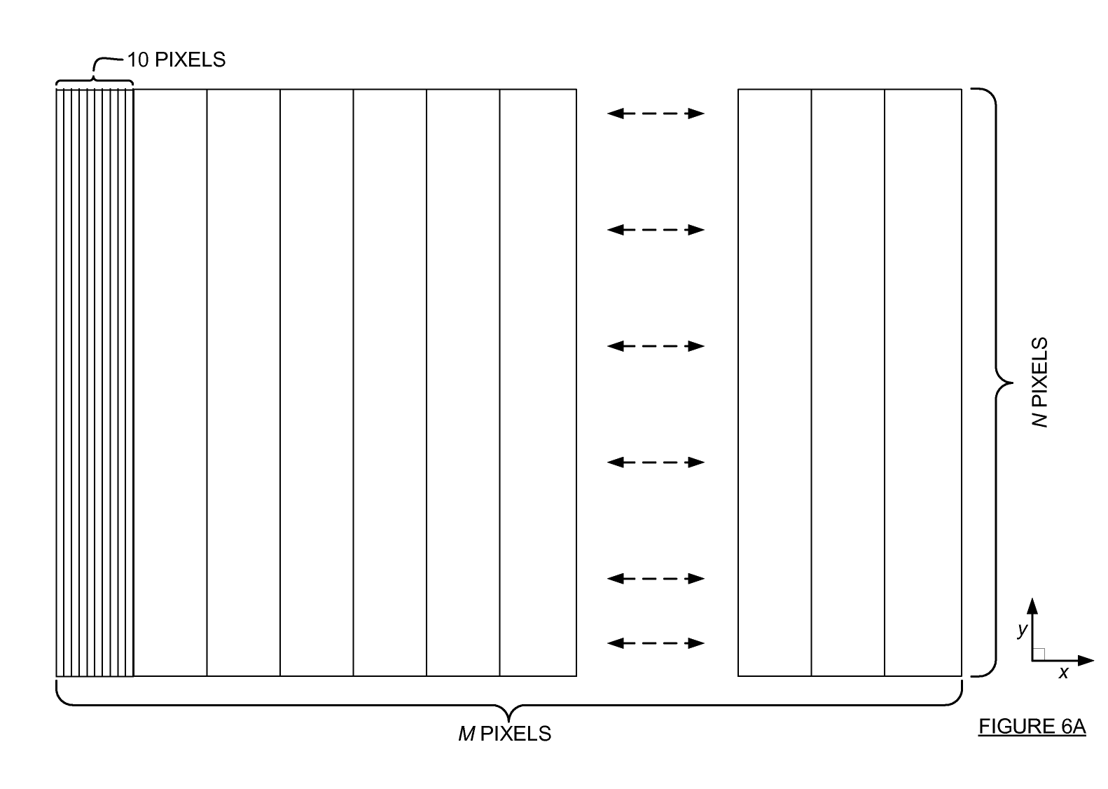

Each one of lenses 14_{A}, 14_{B}, 14_{C}, 14_{D}, 14_{E}, 14_{F}, 14_{G}, 14_{H}, 14_{I}, 14_{J} is a large focal ratio (i.e. f-number) flat-field converging lens, providing a sharp flat field focus on image panel 16. For example, each lens may be a cylindrical meniscus lens designed to have a substantially flat focal surface, and may have an f/10 focal ratio. Each lens has a focal length greater than 5 times the shortest physical extent of the lens. Typically, each lens has a focal length between 5 and 15 times the shortest physical extent of the lens. If the lenses are cylindrical lenses (as depicted in FIGS. 2, 3, 4 and 5A), they may have positive optical power in the x direction, and zero optical power in the y direction. If the lenses are radially symmetric as depicted in FIG. 5C (as opposed to cylindrical lenses having symmetry in only one plane), they may have the same optical power in the x and y directions. The lenses may be arranged in a rectangular array (as shown), in a hexagonal array or in another regular array. As shown in FIG. 3, light-absorptive barriers 17_{A}, 17_{B}, 17_{C}, 17_{D}, 17_{E}, 17_{F}, 17_{G}, 17_{H}, 17_{I}, 17_{J} can be provided between adjacent lenses to prevent passage of light rays between the lenses.

Image panel 16, which may be an electronically controllable LCD panel having approximately the same physical extent as lens array 14, is positioned with its normal direction parallel to the optical axes of the lenses in lens array 14 (i.e. parallel to the z direction), at the focal plane of the lenses. The total number of pixels in lens array 14 is significantly greater than the total number of lenses in lens array 14, i.e. at least 5:1. If the lenses are cylindrical lenses, the number of pixels may be between 5 and 15 times greater than the number of lenses. If the lenses are radially symmetric lenses, the number of pixels may be between 25 and 200 times greater than the number of lenses.

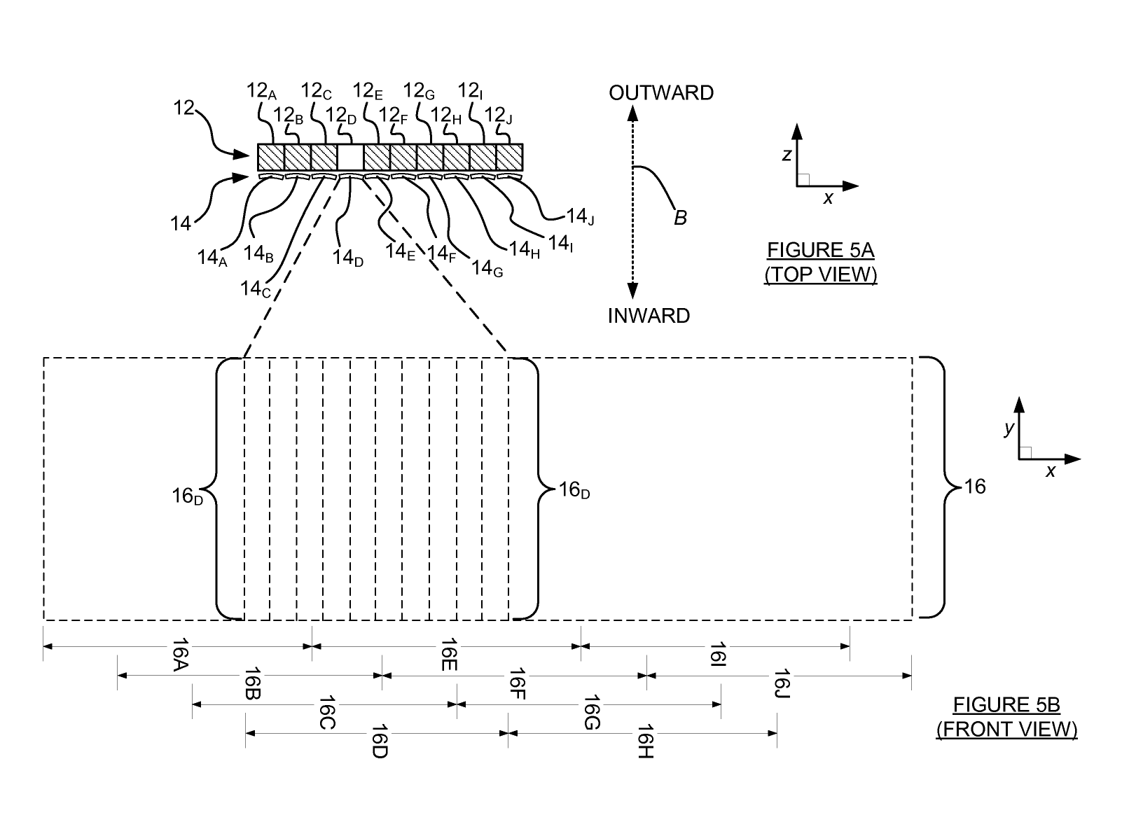

Controller 19 turns selected subsets of aperture mask 12's electro-optic switches “on” and turns the remaining switches “off” in a manner that allows the lenses aligned with the “on” switches to focus, through the “on” switches, light rays which emanate from non-overlapping portions of image panel 16—each portion having an area exceeding the area of an individual lens. By repetitively and sequentially switching selected switch subsets, controller 19 turns each switch in each subset “on” for an equal portion of a selected time interval, with a frequency exceeding the flicker fusion frequency of the human visual perception system. Controller 19 also repetitively and sequentially applies an image to image panel 16, in synchronization with the “on” and “off” switching of aperture mask 12's electro-optic switches. Specifically, controller 19 applies selected sections of the image to the portions of image panel 16 which correspond to the “on” switches. The lenses aligned with the “on” switches accordingly receive and focus through those “on” switches light rays which emanate from the corresponding sections of the image. Repetitive, rapid sequential application of different sections of the image to corresponding portions of image panel 16, and synchronized repetitive, rapid sequential turning “on” of the switches in aperture mask 12 associated with corresponding portions of image panel 16 yields the desired integral high resolution 3D image effect, as explained below with reference to FIGS. 4, 5A, 5B and 7A-7J.

Lens array 14 and image panel 16 are spaced apart such that each one of lenses 14_{A}, 14_{B}, 14_{C}, 14_{D}, 14_{E}, 14_{F}, 14_{G}, 14_{H}, 14_{I}, 14_{J} corresponds to a different one of image regions 16_{A}, 16_{B}, 16_{C}, 16_{D}, 16_{E}, 16_{F}, 16_{G}, 16_{H}, 16_{I}, 16_{J} (FIG. 5B) on image panel 16. Each image region is roughly ten times larger than the corresponding lens. For example, if each lens is about 1 mm in diameter, then each image region is about 10 mm in diameter. Accordingly, if image panel 16 is spaced 10 mm inwardly from lens array 14, and if the lenses are cylindrical lenses (as depicted in FIGS. 2, 3, 4 and 5A), each image region consists of ten separate image pixel strips on LCD image panel 16—each pixel strip having a height of 100 microns. Alternatively, if the lenses are radially symmetric as depicted in FIG. 5C, and if image panel 16 is spaced 10 mm inwardly from lens array 14, each image region consists of one hundred separate image pixels on LCD image panel 16—each pixel having a width of 1 mm, where each pixel strip consists of 10 lines of pixels each 100 microns wide. In either case, high image resolution equivalent to that attainable by one-dimensional integral image photography is attained, facilitating production of high resolution 3D images having substantial image depth perceivable by viewer V.

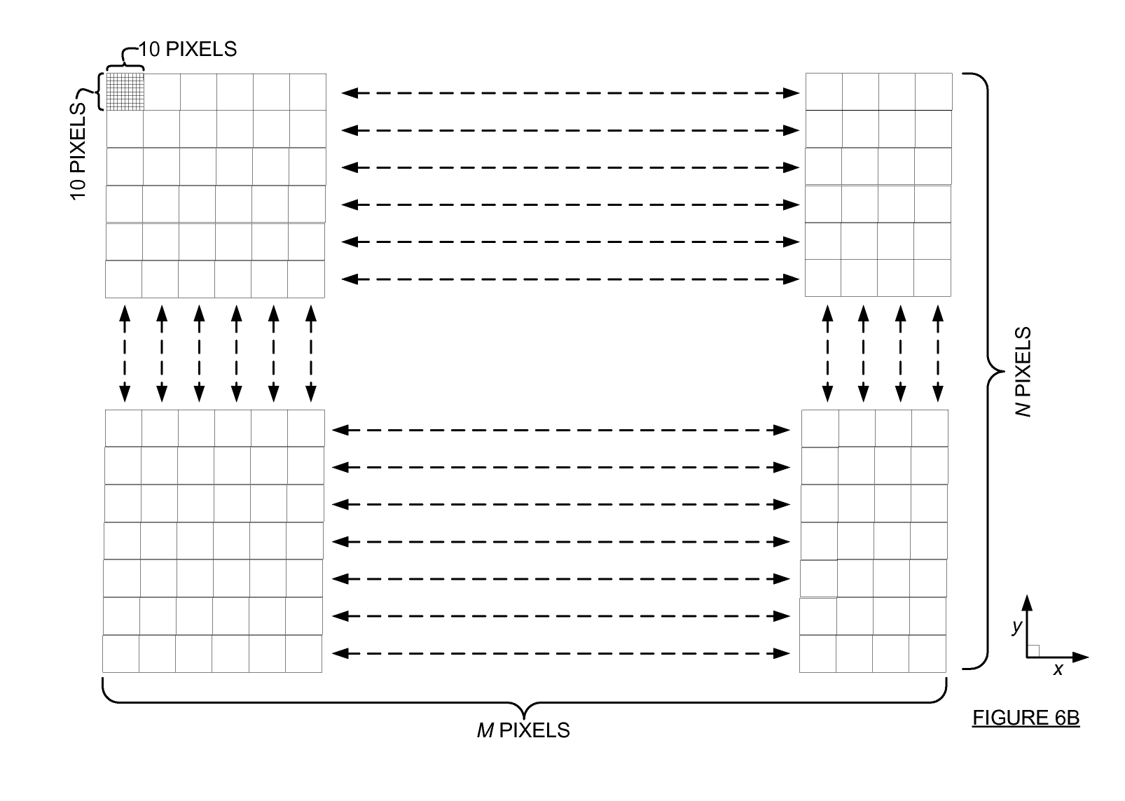

FIG. 6A schematically depicts an M by N pixel array corresponding to a display utilizing cylindrical lenses, with M and N being the number of image pixels in the display's x and y directions respectively. In a display incorporating cylindrical lenses, each group of ten cylindrical lenses corresponds to a group of ten image pixel strips similar to image region 16_{D} shown in FIG. 5B. A plurality of groups of cylindrical lenses are aligned in the y direction to produce a corresponding plurality of image pixel strips aligned in the y direction, yielding a substantially continuous and aligned group of ten image pixel strips collectively providing N pixels in the y direction, as shown in FIG. 6A. A plurality of groups of cylindrical lenses are also aligned in the x direction to produce a further plurality of image pixel strips adjacent one another in the x direction, collectively providing M pixels in the x direction, as shown in FIG. 6A.

FIG. 6B schematically depicts an M by N pixel array corresponding to a display utilizing conventional radially symmetric lenses, with M and N again being the number of image pixels in the display's x and y directions respectively. In a display incorporating radially symmetric lenses, each lens corresponds to a 10 by 10 array of image pixels (i.e. one hundred pixels), similar to image region 16_{D} shown in FIG. 5D. The lenses are aligned in the y direction to produce a corresponding plurality of 10 by 10 image pixel arrays aligned in the y direction, yielding a substantially continuous and aligned group of 10 by 10 image pixel arrays collectively providing N pixels in the y direction, as shown in FIG. 6B. The lenses are also aligned in the x direction to produce a further plurality of 10 by 10 image pixel arrays adjacent one another in the x direction, collectively providing M pixels in the x direction, as shown in FIG. 6B.

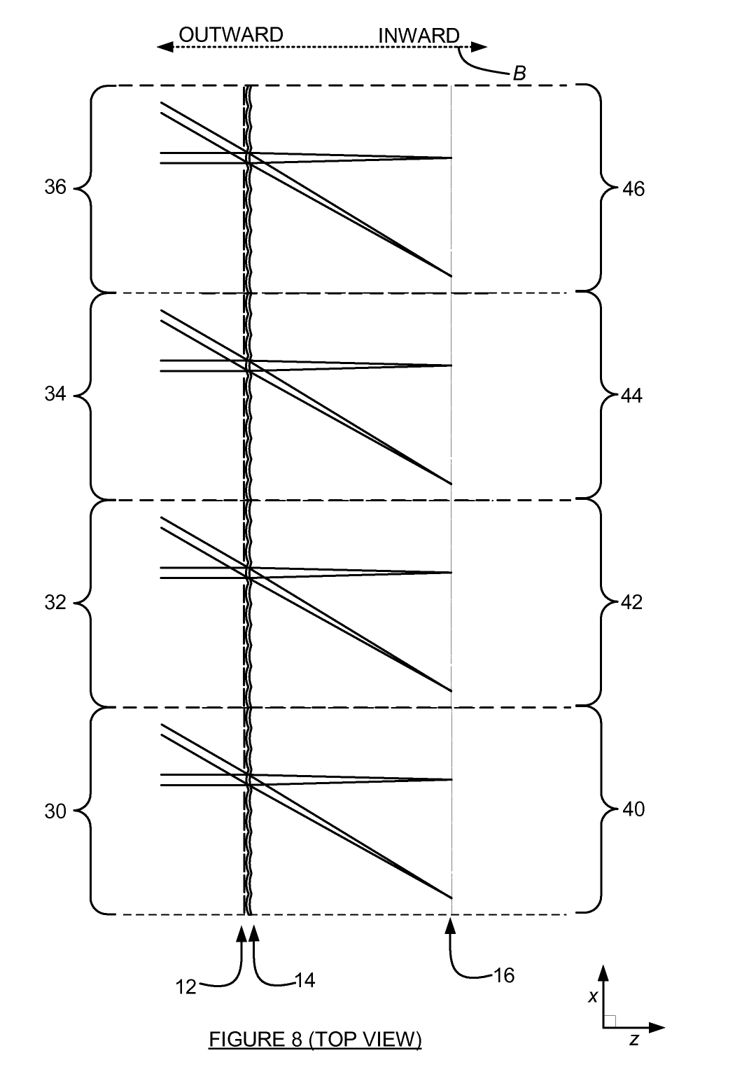

A display utilizing cylindrical lenses may incorporate groups of ten linearly adjacent LCD elements and lenses, as described above. FIG. 8 schematically depicts four such linearly adjacent groups 30, 32, 34, 36 of ten LCD elements 12 and ten lenses 14 respectively aligned with four linearly adjacent imaging panel portions 40, 42, 44, 46 of image panel 16. As shown in FIG. 8, corresponding ones of the LCD elements within each one of groups 30, 32, 34, 36 are simultaneously selectably actuated to permit light rays to pass through one lens and one LCD element in each group. Within each group of ten LCD elements and lenses, each LCD element is repetitively and sequentially switched “on” 10% of the time the display operates, and is switched “off” 90% of the time the display operates. By contrast, a corresponding display utilizing conventional radially symmetric lenses may incorporate groups of one hundred LCD elements and lenses, with each group arranged in a 10 by 10 rectangular array. Within each group of one hundred, each LCD element is repetitively and sequentially switched “on” 1% of the time the display operates, and is switched “off” 99% of the time the display operates. An advantage of a display utilizing conventional radially symmetric lenses is that viewer V perceives a 3D image effect while observing display 10 through a significant range of both horizontally and vertically distributed viewing directions (i.e. viewing directions distributed in both the x and y directions depicted in FIGS. 1A and 1B). By contrast, if viewer V observes a display utilizing cylindrical lenses, the 3D image effect is not perceivable through a significant range of vertically distributed viewing directions (i.e. viewing directions distributed in the y direction depicted in FIG. 1A). However, a significant advantage of a display utilizing cylindrical lenses, in comparison to a corresponding display utilizing conventional radially symmetric lenses, is that the light output of the cylindrical lens display is increased by a factor of ten relative to that of the conventional lens display; and the required frequency response of the cylindrical lens display is decreased by a factor of ten relative to that of the conventional lens display. In many situations, viewer V need not observe display 10 through a significant range of vertically distributed viewing directions. A display utilizing cylindrical lenses is a practical alternative to a corresponding display utilizing conventional radially symmetric lenses in such situations.

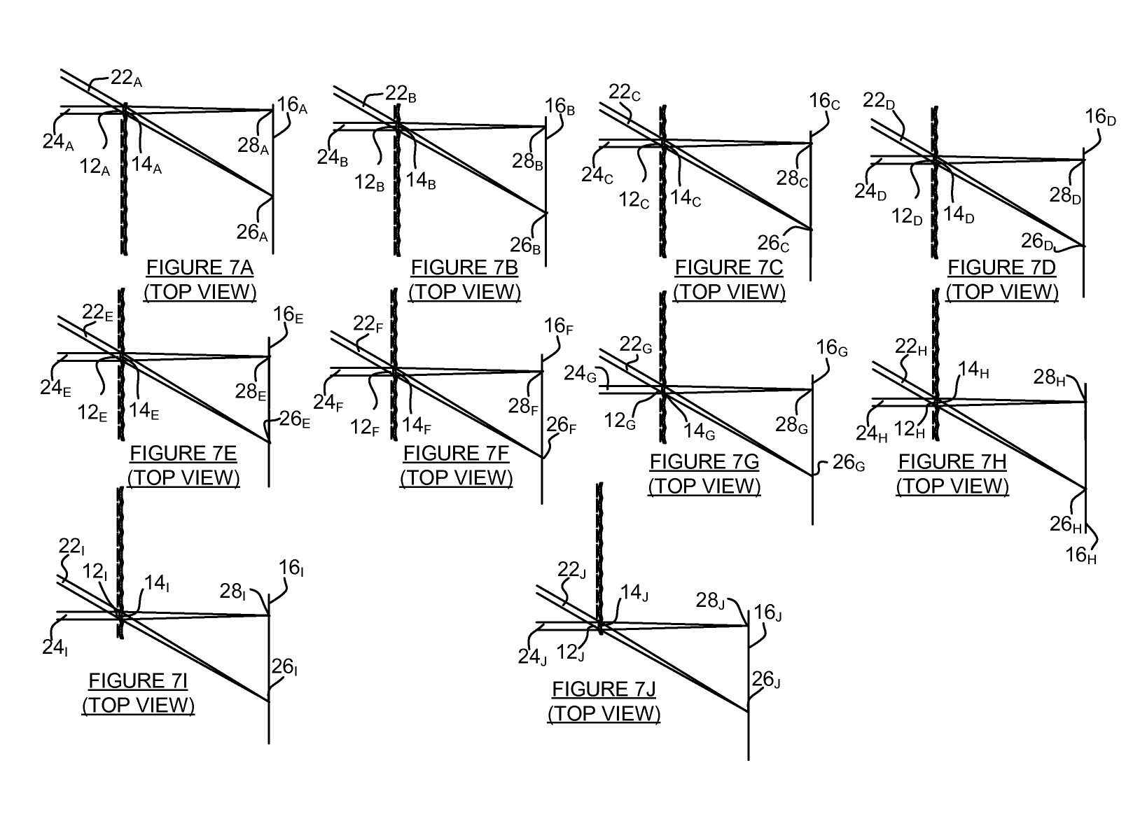

Since each one of cylindrical lenses 14_{A}, 14_{B}, 14_{C}, 14_{D}, 14_{E}, 14_{F}, 14_{G}, 14_{H}, 14_{I}, 14_{J} corresponds to ten separate image pixels on LCD image panel 16, display 10 can simultaneously display one hundred separate images. However, if nothing further is done, the displayed images will overlap, unacceptably degrading the image viewing experience. This is illustrated in FIGS. 5A, 5B and 7A-7J. FIG. 7A shows LCD element 12_{A} “on” and LCD elements 12_{B}, 12_{C}, 12_{D}, 12_{E}, 12_{F}, 12_{G}, 12_{H}, 12_{I}, 12_{J}” “off” during a first time interval. Lens 14_{A} focuses through LCD element 12_{A} (i.e. to the left, toward viewer V) light rays 22_{A} which correspond to a particular viewing angle and emanate from pixel 26_{A} of image region 16_{A}. Lens 14_{A} simultaneously focuses through LCD element 12_{A} light rays 24_{A} which correspond to another viewing angle and emanate from a different pixel 28_{A} of image region 16_{A}. Lens 14_{A} similarly simultaneously focuses through LCD element 12_{A} one hundred sets of light rays—each set emanating from a different one of the one hundred pixels constituting image region 16_{A} and corresponding to one of one hundred different horizontally and angularly distributed viewing directions A through which viewer V may look at display 10. FIG. 7A depicts only two of the one hundred sets of light rays to avoid obscuring the details depicted in FIG. 7A.

FIG. 7B shows LCD element 12_{B} “on” and LCD elements 12_{A}, 12_{C}, 12_{D}, 12_{E}, 12_{F}, 12_{G}, 12_{H}, 12_{I}, 12_{J} “off” during a second time interval subsequent to the first time interval. Lens 14_{B} is thus able, during the second time interval, to simultaneously focus through LCD element 12_{B} (i.e. to the left, toward viewer V) one hundred sets of light rays which emanate from image region 16_{B}—each set emanating from a different one of the one hundred pixels constituting image region 16_{B} and corresponding to one of one hundred different horizontally and angularly distributed viewing directions A. FIGS. 7C-7J similarly respectively depict lenses 14_{C}, 14_{D}, 14_{E}, 14_{F}, 14_{G}, 14_{H}, 14_{I}, 14_{J} simultaneously focusing through LCD elements 12_{C}, 12_{D}, 12_{E}, 12_{F}, 12_{G}, 12_{H}, 12_{I}, 12_{J} respectively (toward viewer V) one hundred sets of light rays which emanate from each of image regions 16_{C}, 16_{D}, 16_{E}, 16_{F}, 16_{G}, 16_{H}, 16_{I}, 16_{J} respectively during respectively subsequent and successive third, fourth, fifth, sixth, seventh, eighth, ninth and tenth time intervals. The LCD elements need not be switched “on” and “off” in sequential order, but may be switched “on” and “off” in a well-determined non-sequential order. For example, the switching order may be random such that all ten LCD elements in a group are switched “on” and “off” in a randomly ordered sequence, before the switching pattern is repeated by again switching the same ten LCD elements “on” and “off” in the same randomly ordered sequence, and so on. Such randomly ordered switching may reduce the capability of viewer V to discern and be distracted by the switching pattern, in comparison to a more readily discernable and potentially distracting sequentially ordered switching pattern.

If one of lenses 14_{A}, 14_{B}, 14_{C}, 14_{D}, 14_{E}, 14_{F}, 14_{G}, 14_{H}, 14_{I}, 14_{J} were able to focus through one of LCD elements 12_{A}, 12_{B}, 12_{C}, 12_{D}, 12_{E}, 12_{F}, 12_{G}, 12_{H}, 12_{I}, 12_{J} one set of light rays emanating from one of image regions 16_{A}, 16_{B}, 16_{C}, 16_{D}, 16_{E}, 16_{F}, 16_{G}, 16_{H}, 16_{I}, 16_{J}; while another one of those lenses focused through another one of those LCD elements another set of light rays emanating from another one of those image regions, the two sets of focused rays would overlap (because the image regions overlap as shown schematically in FIG. 5B) unacceptably degrading viewer V's image viewing experience.

To avoid such overlap, aperture mask 12 is controllably actuated such that viewer V sees only one of lenses 14_{A}, 14_{B}, 14_{C}, 14_{D}, 14_{E}, 14_{F}, 14_{G}, 14_{H}, 14_{I}, 14_{J} during any one time interval. More particularly, aperture mask 12 is actuated such that only one of LCD elements 12_{A}, 12_{B}, 12_{C}, 12_{D}, 12_{E}, 12_{F}, 12_{G}, 12_{H}, 12_{I}, 12_{J} is in the transparent “on” state during any one time interval, with the other nine LCD elements remaining in the opaque “off” state during that time interval, as shown in FIGS. 4, 5A and 5B.

For example, as shown in FIGS. 4 and 5A, LCD element 12_{D} has been actuated (in a manner well known to persons skilled in the art) such that LCD element 12_{D} is “on”. LCD element 12_{D} is accordingly transparent, allowing light rays emanating from any of the one hundred pixels constituting image region 16_{D} to be simultaneously focused through LCD element 12_{D} by lens 14_{D}. The other nine LCD elements 12_{A}, 12_{B}, 12_{C}, 12_{E}, 12_{F}, 12_{G}, 12_{H}, 12_{I}, 12_{J} shown in FIGS. 4 and 5A are actuated such that those nine LCD elements are “off” (indicated by cross-hatching in FIG. 5A). Those nine “off” LCD elements are accordingly each opaque, preventing passage of light rays through any of those nine LCD elements. Lens 14_{D} is accordingly able to focus through LCD element 12_{D} toward viewer V light rays emanating from any of the one hundred pixels constituting image region 16_{D}, but none of lenses 14_{A}, 14_{B}, 14_{C}, 14_{E}, 14_{F}, 14_{G}, 14_{H}, 14_{I}, 14_{J} is able to focus light rays through any of LCD elements 12_{A}, 12_{B}, 12_{C}, 12_{E}, 12_{F}, 12_{G}, 12_{H}, 12_{I}, 12_{J}.

Each one of LCD elements 12_{A}, 12_{B}, 12_{C}, 12_{D}, 12_{E}, 12_{F}, 12_{G}, 12_{H}, 12_{I}, 12_{J} is rapidly, sequentially and repetitively turned “on” while the other nine LCD elements are turned off. Light rays emanating from any of the one hundred pixels constituting the image region corresponding to the “on” LCD element are simultaneously focused through the “on” LCD element by the lens corresponding to the “on” LCD element, while light rays emanating from pixels constituting image regions corresponding to the “off” LCD elements are blocked. Light rays emanating from each pixel correspond to different images, and also correspond to one of one hundred different horizontally and angularly distributed viewing directions A through which viewer V may look at display 10.

Aperture mask 12 need only be selectably actuable to switch LCD elements 12_{A}, 12_{B}, 12_{C}, 12_{D}, 12_{E}, 12_{F}, 12_{G}, 12_{H}, 12_{I}, 12_{J} at high frequency between the “on” and “off” states. Accordingly, aperture mask 12 need only have a monochrome (i.e. black & white) characteristic. An angular viewing accuracy of ±0.5 milliradians is attainable for objects depicted to be near display 10's viewing surface if viewer V is located 1 metre outwardly away from display 10's viewing surface. An angular viewing accuracy of no more than ±5 milliradians is attainable for objects depicted to be at infinity. This gives viewer V a significant sense of image depth—comparable to looking through a window—while simultaneously depicting nearby objects at high resolution. If the LCD elements are electrically interconnected in groups of ten elements per group, then controller 19 may be actuated to switch 10% of the total number of elements in the display “on” during any one time interval. If there are more than ten LCD elements per group, then controller 19 may switch fewer than 10% of the total number of elements in the display “on” during any one time interval, thus reducing power consumption but also reducing display brightness. If there are fewer than 10 LCD elements per group, then controller 19 should switch more than 10% of the total number of elements in the display “on” during any one time interval, thus increasing display brightness but also increasing power consumption.

If aperture mask 12 and image panel 16 are both LCD sheets, and if both sheets are capable of 8-bit control (i.e. if each LCD element has eight possible switching states, instead of just two), 16-bit image depth can be attained. The display's efficiency can be improved by forming backlight 18 of a plurality of localized strip light sources such as organic light-emitting diodes (OLEDs). Such strip light sources can be more efficiently optically coupled to the LCD elements constituting aperture mask 12. More particularly, each strip light source can be selectably switched “on” and “off” in synchronization with the “on” and “off” switching of corresponding ones of the LCD elements. This facilitates illumination of only those LCD elements which are in the transparent “on” state, and avoids unnecessary illumination of LCD elements which are in the opaque “off” state.

A 3D image can be produced for viewing on display 10 by digitally photographing a real 3D scene from one hundred different horizontally and angularly distributed viewing directions. Each digital photograph consists of a data structure. If image panel 16 consists of a plurality of 100-pixel image regions, then each data structure is divided into a plurality of 100-pixel sub-structures, with each sub-structure corresponding to a different one of image panel 16's 100-pixel image regions.

As previously explained, controller 19 turns selected subsets of aperture mask 12's electro-optic switches “on” and turns the remaining switches “off” in a manner that allows the lenses aligned with the “on” switches to focus, through the “on” switches, light rays which emanate from non-overlapping portions of image panel 16. The resultant 3D image effect can be understood by imagining that, instead of image panel 16, the actual 3D scene to be displayed is positioned on the inward side of aperture mask 12 and lens array 14, in substitution for image panel 16. When a particular group of LCD elements in aperture mask 12 is turned “on” (i.e. opened) viewer V perceives one scene, whereas when a different group of LCD elements is turned “on” viewer Vperceives a slightly different scene because the viewing angles corresponding to the two groups of elements are slightly different and therefore light emanates at slightly different angles from the 3D scene through the respective groups to viewer V. These slight differences cause viewer V to perceive depth in the scene.

While a number of exemplary aspects and embodiments have been discussed above, those of skill in the art will recognize certain modifications, permutations, additions and sub-combinations thereof. For example, in a display utilizing cylindrical lenses, instead of arranging the LCD elements and lenses in groups of ten as aforesaid, one may arrange them in groups of more or less than ten. However, as the group size increases, the amount of light emitted by the display when each LCD element is in the “on” state decreases, causing a corresponding undesirable decrease in the display's brightness. Increasing the group size also necessitates an increase in the display's frequency response to facilitate sequential “on” and “off” switching of all of the LCD elements in each group at the corresponding frame rate. As the group size decreases, the display's resolution decreases, which is undesirable. A reasonable compromise is attained with a group size of ten, although other group sizes from eight to twelve are acceptable.

As another example, corresponding LCD elements within different groups can be electronically controlled in parallel with one another to reduce the complexity of controller 19. For example, if a display has a total of one thousand LCD elements, those elements can be arranged in one hundred different groups of ten LCD elements per group. The first LCD element in each group can be controlled by a first electronic switch such that all one hundred of the first LCD elements can be simulta- neously switched “on” by the first switch during a first time interval and simultaneously switched “off during subsequent time intervals; the second LCD element in each group can be controlled by a second electronic switch such that all one hundred of the second LCD elements can be simultaneously switched “on“by the second switch during a second time interval and simultaneously switched “off during subsequent time intervals; etc.

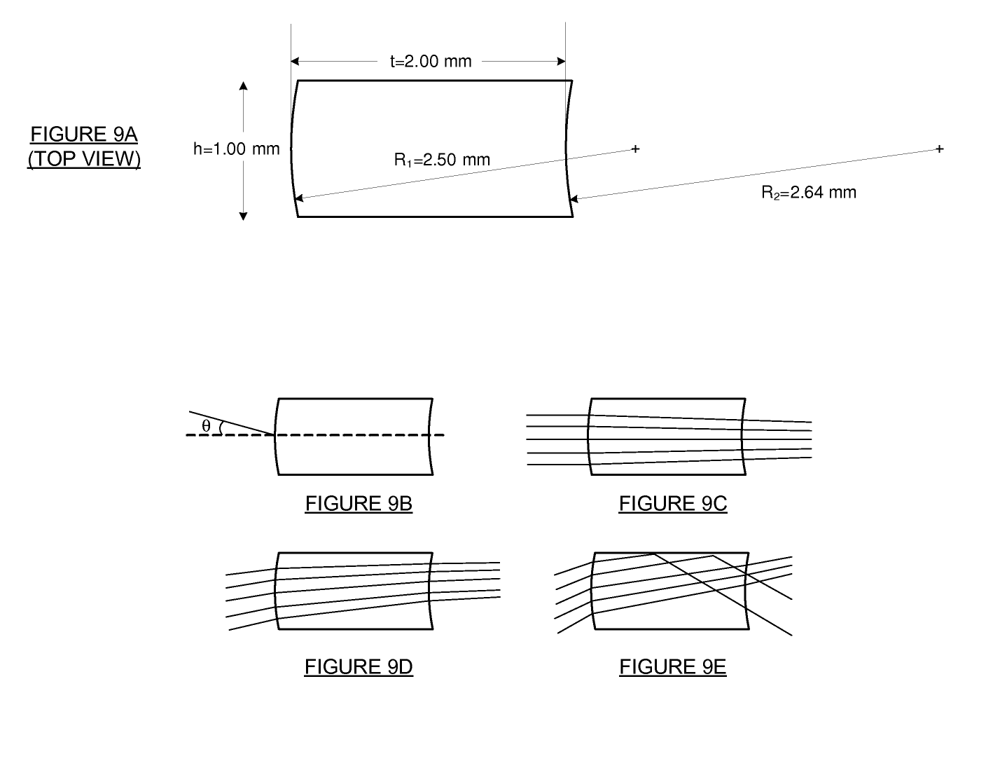

FIG. 9A depicts a desirable size and shape for one lenslet of a lenticular meniscus lens array such as lens array 14. Ray tracing simulations can be used to determine the path of light rays incident on the FIG. 9A lenslet for a range of incidence angles θ=0° to θ=25°, where the angle θ is shown in FIG. 9B. The FIG. 9A lenslet is capable of focusing such incident light rays to a focal plane located 10 mm away, with less than 0.1 mm variation in the focal position. FIGS. 9C, 9D and 9E schematically depict the path of the light rays for different incidence angles. At small angles, as shown in FIGS. 9C and 9D, all of the light rays pass through the single lenslet. For larger angles, as shown in FIG. 9E, some light rays intercept the side of the lenslet. If a plurality of lenslets are provided adjacent one another to form an array such as lens array 14 depicted in FIG. 3, a light ray entering one lenslet may exit through an adjacent lenslet. This undesirably degrades image quality, but may be prevented by providing a light absorptive strip in at least a portion of the region between adjacent lenslets. For example, as previously mentioned, light-absorptive barriers 17_{A}, 17_{B}, 17_{C}, 17_{D}, 17_{E}, 17_{F}, 17_{G}, 17_{H}, 17_{I}, 17_{J} can be provided between adjacent lenses to prevent passage of light rays between the lenses. This will reduce the brightness of the display at large off-axis viewing angles, but will maintain image quality.

It is intended that the following appended claims and claims hereafter introduced are interpreted to include all such modifications, permutations, additions and sub-combinations as are within their true spirit and scope.

What is claimed is:

1. A display, comprising:
a backlight;
a substantially planar image panel positioned on an outward side of the backlight;
a substantially planar lens array positioned on an outward side of the image panel, the lens array comprising a plurality of converging lenses, each lens having an optical axis substantially perpendicular to the image panel;
a substantially planar aperture mask positioned on an outward side of the lens array, the aperture mask comprising a plurality of electro-optic elements, each element being aligned closely proximate to a corresponding one of the lenses and selectably switchable between an “on” state in which the element permits passage of light rays through the element and an “off” state in which the element prevents passage of light rays through the element, wherein the electro-optic elements are arranged in subsets of adjacent elements;
a controller electronically coupled to the image panel and to the aperture mask, the controller operable to repetitively:
select an electro-optic element in each subset of the electro-optic elements;
switch the selected elements “on” and switch all other elements in each subset “off” ; and
apply to the image panel a selected plurality of representations of an image corresponding to the selected “on” elements, each representation corresponding to a plurality of different viewing directions of the image.

2. An image display as defined in claim 1, wherein the lenses are cylindrical lenses having positive optical power in a first direction perpendicular to the optical axis and zero optical power in a second direction perpendicular to the optical axis.

3. An image display as defined in claim 2, wherein each lens has a flat focal field.

4. An image display as defined in claim 2, wherein the lenses are arranged in groups of horizontally adjacent lenses, each group corresponding to a subset of the electro-optic elements.

5. An image display as defined in claim 4, wherein each lens has a width of about 1 mm.

6. An image display as defined in claim 4, wherein each lens has a shortest physical extent perpendicular to the optical axis of the lens, of between 0.5 mm to 1.5 mm.

7. An image display as defined in claim 6, wherein each lens has a focal length greater than 5 times the shortest physical extent of the lens.

8. An image display as defined in claim 6, wherein each lens has a focal length between 5 and 15 times the shortest physical extent of the lens.

9. An image display as defined in claim 2, wherein each lens is a meniscus lens.

10. An image display as defined in claim 1, wherein the lenses are radially symmetric lenses having positive optical power in first and second directions perpendicular to the optical axis.

11. An image display as defined in claim 10, wherein each lens has a flat focal field.

12. An image display as defined in claim 10, wherein the lenses are arranged in regular array groups of adjacent lenses, each group corresponding to a subset of the electro-optic elements.

13. An image display as defined in claim 12, wherein each lens has a diameter of about 1 mm.

14. An image display as defined in claim 12, wherein each lens has a shortest physical extent perpendicular to the optical axis of the lens, of between 0.5 mm to 1.5 mm.

15. An image display as defined in claim 14, wherein each lens has a focal length greater than 5 times the shortest physical extent of the lens.

16. An image display as defined in claim 14, wherein each lens has a focal length between 5 and 15 times the shortest physical extent of the lens.

17. An image display as defined in claim 10, wherein each lens is a meniscus lens.

18. An image display as defined in claim 1, wherein:
the lenses have a common focal plane;
the image panel is positioned at the focal plane;
the image panel has an area approximately equal to an area of the lens array;
the image panel has a plurality of pixels; and
the number of pixels is significantly greater than the number of lenses.

19. An image display as defined in claim 18, wherein:
for each selected subset of the electro-optic elements, each lens proximate to an electro-optic element in the selected subset corresponds to a portion of the image panel which does not overlap any other portion of the image panel corresponding to any other lens proximate to any other electro-optic element in the selected subset; and
any one of the portions of the image panel has an area greater than an area of any one of the lenses.

20. An image display as defined in claim 19, wherein the controller is further operable to switch the selected elements “on” and switch all other elements in each subset “off” for equal duration time intervals at a frequency greater than the flicker fusion frequency of the human visual perception system.

21. An image display as defined in claim 20, wherein the controller is further operable to switch the selected elements “on” and switch all other elements in each subset “off” in a predetermined non-sequential order.

22. An image display as defined in claim 20, wherein the non-sequential order is random.

23. An image display as defined in claim 18, wherein the number of pixels is at least 5 times greater than the number of lenses.

24. An image display as defined in claim 18, wherein:
the lenses are cylindrical lenses having positive optical power in a first direction perpendicular to the optical axis and zero optical power in a second direction perpendicular to the optical axis; and
the number of pixels is between 5 and 15 times greater than the number of lenses.

25. An image display as defined in claim 18, wherein:
the lenses are radially symmetric lenses having positive optical power in first and second directions perpendicular to the optical axis; and
the number of pixels is between 25 and 200 times greater than the number of lenses.

26. An image display as defined in claim 1, further comprising a light-absorptive barrier between adjacent lenses to prevent passage of light rays between the lenses.

27. An image display as defined in claim 20, wherein the controller is further operable to switch no more than 20% of the electro-optic elements “on” during any one of the time intervals.

28. An image display as defined in claim 20, wherein the controller is further operable to switch between 5% and 15% of the electro-optic elements “on” during any one of the time intervals.

29. An image display as defined in claim 23, wherein each lens has a flat focal field.

30. An image display as defined in claim 29, wherein the controller is further operable to:
switch the selected elements “on” and switch all other elements in each subset “off” for equal duration time intervals at a frequency greater than the flicker fusion frequency of the human visual perception system; and
switch no more than 20% of the electro-optic elements “on” during any one of the time intervals.

31. An image display as defined in claim 3, wherein the controller is further operable to:
switch the selected elements “on” and switch all other ele- ments in each subset “off” for equal duration time intervals at a frequency greater than the flicker fusion frequency of the human visual perception system; and
switch no more than 20% of the electro-optic elements “on” during any one of the time intervals.

32. An image display as defined in claim 2, wherein the controller is further operable to:
switch the selected elements “on” and switch all other elements in each subset “off” for equal duration time intervals at a frequency greater than the flicker fusion frequency of the human visual perception system; and
switch no more than 20% of the electro-optic elements “on” during any one of the time intervals.

33. An image display as defined in claim 23, wherein the controller is further operable to:
switch the selected elements “on” and switch all other elements in each subset “off” for equal duration time intervals at a frequency greater than the flicker fusion frequency of the human visual perception system; and
switch no more than 20% of the electro-optic elements “on” during any one of the time intervals.

34. An image display as defined in claim 25, wherein each lens is a meniscus lens.

35. An image display as defined in claim 34, further comprising a light-absorptive barrier between adjacent lenses to prevent passage of light rays between the lenses.

36. An image display as defined in claim 35, wherein the controller is further operable to:
switch the selected elements “on” and switch all other ele- ments in each subset “off” for equal duration time intervals at a frequency greater than the flicker fusion frequency of the human visual perception system; and
switch between 5% and 15% of the electro-optic elements “on” during any one of the time intervals.

37. An image display as defined in claim 36, wherein each lens has a focal length between 5 and 15 times the shortest physical extent of the lens.

38. An image display as defined in claim 31, wherein:
the lenses are cylindrical lenses having positive optical power in a first direction perpendicular to the optical axis and zero optical power in a second direction perpendicular to the optical axis; and
the number of pixels is between 5 and 15 times greater than the number of lenses.

39. An image display as defined in claim 31, wherein:
the lenses are radially symmetric lenses having positive optical power in first and second directions perpendicular to the optical axis; and
the number of pixels is between 25 and 200 times greater than the number of lenses.

40. An image display as defined in claim 39, wherein each lens is a meniscus lens.

41. An image display as defined in claim 40, further comprising a light-absorptive barrier between adjacent lenses to prevent passage of light rays between the lenses.

42. An image display as defined in claim 41, wherein the controller is further operable to:
switch the selected elements “on” and switch all other elements in each subset “off” for equal duration time intervals at a frequency greater than the flicker fusion frequency of the human visual perception system; and
switch between 5% and 15% of the electro-optic elements “on” during any one of the time intervals.

43. An image display as defined in claim 42, wherein each lens has a focal length between 5 and 15 times the shortest physical extent of the lens.

44. A method of displaying an image on a two-dimensional plane such that a viewer perceives depth in the displayed image, the method comprising:
producing a first plurality of image data structures, each data structure defining the image as seen from a different one of a first plurality of horizontally and angularly distributed viewing directions;
providing an image panel having a second plurality of image regions, each image region comprising an M by N array of image pixels, where M and N are integers;
dividing each one of the image data structures into image sub-structures, each sub-structure comprising an M by N array of image pixels corresponding to a unique one of the viewing directions and to a unique one of the image regions;
providing a plurality of converging lenses on an outward side of the image panel, each lens having an optical axis substantially perpendicular to the image panel;
providing a plurality of electro-optic elements on an outward side of the lenses, each element being selectably switchable between an “on” state permitting passage of light rays through the element and an “off” state preventing passage of light rays through the element;
aligning each element closely proximate to a corresponding one of the lenses;
arranging the elements in subsets of adjacent elements; repetitively:
selecting a sequentially next element in each one of the subsets; and
switching the selected elements “on” and switching all other elements in each subset “off” while applying to each one of the image regions a different one of the image sub-structures corresponding to that one of the image regions and corresponding to an “on” element associated with that one of the image regions.

45. A method as defined in claim 44, wherein the number of pixels is at least 5 times greater than the number of lenses.

46. A method as defined in claim 44, wherein each lens has a flat focal field.

47. A method as defined in claim 44, wherein switching the selected elements further comprises:
switching the selected elements “on” and switching all other elements in each subset “off” for equal duration time intervals at a frequency greater than the flicker fusion frequency of the human visual perception system; and
switching no more than 20% of the electro-optic elements “on” during any one of the time intervals.

48. A method as defined in claim 45, wherein each lens has a flat focal field.

49. A method as defined in claim 45, wherein switching the selected elements further comprises:
switching the selected elements “on” and switching all other elements in each subset “off” for equal duration time intervals at a frequency greater than the flicker fusion frequency of the human visual perception system; and
switching no more than 20% of the electro-optic elements “on” during any one of the time intervals.

50. A method as defined in claim 46, wherein switching the selected elements further comprises:
switching the selected elements “on” and switching all other elements in each subset “off” for equal duration time intervals at a frequency greater than the flicker fusion frequency of the human visual perception system; and
switching no more than 20% of the electro-optic elements “on” during any one of the time intervals.

51. A method as defined in claim 48, wherein switching the selected elements further comprises:
switching the selected elements “on” and switching all other elements in each subset “off” for equal duration time intervals at a frequency greater than the flicker fusion frequency of the human visual perception system; and
switching no more than 20% of the electro-optic elements “on” during any one of the time intervals.
